(19) United States
(12) Patent Application Publication
(10) Pub. No.: US 2018/0268622 A1
(43) Pub. Date: Sep. 20, 2018

(54) DISTRIBUTED VEHICLE DATA STORAGE AND ACCESS

(71) Applicant: FORD GLOBAL TECHNOLOGIES, LLC, Dearborn, MI (US)

(72) Inventors: Perry Robinson MACNEILLE, Lathrup Village, MI (US); Yimin LIU, Ann Arbor, MI (US); Jeffrey YEUNG, Canton, MI (US); Omar MAKKE, Lyon Township, MI (US); Patrick Lawrence Jackson VAN HOECKE, Westland, MI (US)

(21) Appl. No.: 15/462,446

(22) Filed: Mar. 17, 2017

(51) Int. Cl. G07C 5/00; H04L 29/08

(52) U.S. Cl. CPC G07C 5/008; H04L 67/1097; H04L 67/12

(57) ABSTRACT

A system for a vehicle includes a local data server configured to receive, via a network connection with the vehicle, data indicative of operating parameters of the vehicle, define a plurality of indices, each index corresponding to a segment of the received data, send the indices to an end user data server; and, in response to a request, from the end user data server, including at least one of the indices, send the corresponding segment.

### TECHNICAL FIELD

The present disclosure relates to systems and methods for referencing and distributing stored vehicle data.

### BACKGROUND

How, when, and where a given vehicle is driven may provide valuable information to vehicle manufacturers, advertisers, insurers, and others. Vehicle data may, for example, provide clues regarding the performance and health of the vehicle, the operator's driving style and preferences, and much more. Furthermore, analyzing a significant amount of vehicle data may reveal meaningful performance and use patterns and trends that may, in turn, assist manufacturers and advertisers in providing a better driver experience and improving vehicle quality and reliability.

The vehicle data analytics may, therefore, assist in establishing a stronger competitive position, provide new revenue opportunities, achieve new levels of customer loyalty, efficient operation and revenue growth.

### SUMMARY

A system for a vehicle includes a local data server configured to receive, via a network connection with the vehicle, data indicative of operating parameters of the vehicle, define a plurality of indices, each index corresponding to a segment of the received data, send the indices to an end user data server; and, in response to a request, from the end user data server, including at least one of the indices, send the corresponding segment.

A method includes receiving, by a local data server connected with a vehicle using a communication network connection, data indicative of operating parameters of the vehicle, defining a plurality of indices, each index corresponding to a segment of the received data, sending the indices to an end user data server; and, in response to a request, from the end user data server, including at least one of the indices, sending the corresponding segment.

A local data server includes a processor connected to a transceiver and configured to establish, via the transceiver, a short-range high-speed network connection with a vehicle and a cellular network connection with a remote data server to send and receive data therefrom, wherein the processor is further configured to store the data received via the transceiver from the vehicle, the data being indicative of a plurality of operating parameters of the vehicle, define a plurality of indices, each index corresponding to and describing a subset of the stored data, send the indices to the remote data server, and, in response to receiving, from the remote data server, a request including at least one of the indices, send the corresponding subsets.

### BRIEF DESCRIPTION OF THE DRAWINGS

FIG. 1 is a block diagram illustrating a system for distributed storage and access of vehicle data;

FIG. 2 is a data flow diagram illustrating distributed storage and access of the vehicle data; and

FIG. 3 is a flowchart illustrating an algorithm for distributed storage and access of the vehicle data.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Centralized storage of vehicle data may be impractical due to a high cost and limited availability of resources dedicated to concentrating computing resources and network traffic. Existing data centers are designed for high reliability and higher rates of retrieval than of input. Moreover, long range wireless data communication technologies may be inadequate in transferring the amount of data produced by even a small segment of vehicles currently on the road. To successfully deploy a vehicle data collection system a better system will be needed.

A host server maintained, for example, by a vehicle manufacturer, may be configured to receive and store data corresponding to a plurality of vehicles. The server may be further configured to, responsive to one or more requests to transfer varying amounts of the stored vehicle data, send the data to the server that generated the request. In one example, the request may be for a subset of vehicle data, e.g., some filtered set or a portion of the stored data.

Vehicle data for a given vehicle may be temporarily stored on the vehicle itself. This may help protect data from being tampered with and, therefore, preserve its authenticity. Amount of data being stored on the vehicle may be kept small, such that implementing the distributed vehicle data storage and access system has minimal impact on per-vehicle cost. Nevertheless, one or more vehicle controllers of a given vehicle may be equipped with solid state hard drives or other expanded data storage technologies. Additionally or alternatively, the vehicle controllers may be configured to connect to external storage devices, such as external plug-and-play flash drives, media and/or communication devices and so on.

The vehicle may be configured to periodically, occasionally, or upon request, send all or a portion of the vehicle data to a larger off-board storage device located, for example, at a vehicle owner's home, place of business, and so on. The off-board storage device may include a processor and may be configured to use the vehicle data to perform calculations prior to distributing downstream all or a portion of the received vehicle data. In one example, the off-board storage device may be configured to send all or portion of the received vehicle data responsive to a request from a vehicle manufacturer server, vehicle data end customer, and so on. In another example, the off-board storage device may be configured to index the received vehicle data and sends the indices to the vehicle manufacturer, vehicle data end customer, and so on. The indices corresponding to all or a portion of the vehicle data stored on the off-board storage device may comprise a unique identifier including a description of the vehicle data that the identifier references, such as, but not limited to, time and location the vehicle data was collected, and a vehicle description code, i.e., a code describing make and model of the vehicle, vehicle trim level, and so on. In response to receiving a request including one or more indices, the off-board storage device may be configured to send the vehicle data corresponding to the indices.

By sending indices referencing the vehicle data, and not the vehicle data itself, the off-board storage device may minimize an amount of network traffic. The distributed data storage system may further assist in ensuring rapid data storage, availability of the data for analytics, and robustness, thereby enabling a business model for vehicle data storage and access that supports investment into processing hardware and network traffic costs. The distributed data storage and access system may allow very fast storage and indexing of time and location of the stamped data for easy retrieval by vehicle data end users.

When the vehicle is parked at the owner's home, a place of business, or another parking location, the vehicle and/or the mobile device connected to the vehicle may automatically connect wirelessly to the off-board data storage device and send indexed vehicle data into the write-once-read-many (WORM) data storage on the device. This phase of the distributed data storage and access may be performed using a short-range high bandwidth connection, which may be up to 1000 times faster than a cellular data connection and does not have data limits characteristic of cellular and cable subscription plans. The off-board data storage device sends indices, or other record descriptors, that are much smaller than the vehicle data stored in the storage device. The indices or descriptors may include information describing the portion of the vehicle data they reference, such that the indices may be used to decide whether the corresponding vehicle data should be requested. In response to a request including indices corresponding to the vehicle data stored on the off-board data storage device, the off-board data storage device sends the vehicle data via a home network connection.

The off-board data storage device may include a wireless transceiver configured to connect to the vehicle and/or the mobile device located in or paired to the vehicle. The off-board data storage device may use the transceiver to receive vehicle data from the one or more vehicle controllers for storage and further indexing using a processor, such as a central processing unit (CPU). The processor of the data storage device may be configured to compute indices, or other data descriptors of the corresponding vehicle data segments, and send the indices to the vehicle manufacturer server and other vehicle data end users. The off-board data storage device located where the vehicle typically parks, thus, stores the vehicle data received from the vehicle.

In one example, the vehicle may generate 10 gigabytes of data per day that may off-loaded to the off-board data storage device including a typical solid state storage device like microSD card, flash storage, or with a hard disk drive, typically with a storage capacity of about 5 terabytes. At short range, such as between a few feet and 100 feet, a wireless connection using Wireless Gigabit Alliance (WiGig) communication protocol may, for example, have a data transfer rate of 4,620 Gb/s or −0.5 GB/s. Thus, transferring the vehicle data from the vehicle to the off-board data storage device at the end of each day may take only a few seconds, in contrast to as many as 200 hours the same amount of data take when completed over a typical cellular data network.

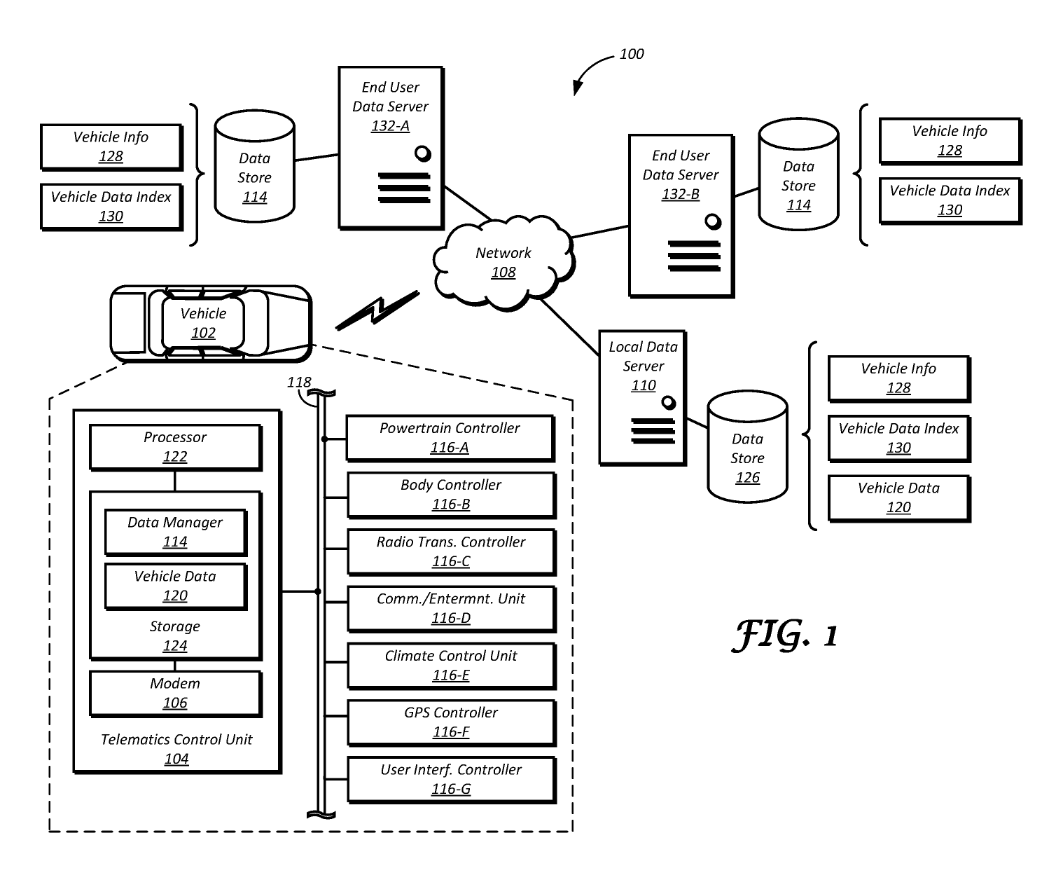

FIG. 1 illustrates an example system 100 for distributed storage and access of vehicle data 120 of a vehicle 102. The vehicle 102 may include a telematics control unit (TCU) 104 having a modem 106 in communication over a network 108 with a local vehicle data server (hereinafter, local server) 110. The local server 110 may communicate with a data store 112 configured to maintain the vehicle data 120 for distribution. The system 100 may further include a vehicle data manager 114 installed to the vehicle 102 and configured to collect the vehicle data 120 from the TCU 104 itself or from other controllers 116 of the vehicle 102. While an example system 100 is shown in FIG. 1, the example components illustrated in the Figure are not intended to be limiting. Indeed, the system 100 may have more or fewer components, and additional or alternative components and/or implementations may be used. As one non-limiting example, the data manager 114 and its corresponding functionality may reside in one or more controllers 116 of the vehicle 102 other than the TCU 104.

The vehicle 102 may include various types of automobile, crossover utility vehicle (CUV), sport utility vehicle (SUV), truck, recreational vehicle (RV), boat, plane or other mobile machine for transporting people or goods. In many cases, the vehicle 102 may be powered by an internal combustion engine. As another possibility, the vehicle 102 may be a hybrid electric vehicle (HEV) powered by both an internal combustion engine and one or more electric motors, such as a series hybrid electric vehicle (SHEV), a parallel hybrid electrical vehicle (PHEV), or a parallel/series hybrid electric vehicle (PSHEV). As the type and configuration of vehicle 102 may vary, the operating characteristics of the vehicle 102 may correspondingly vary. As some other possibilities, vehicle 102 may have different characteristics with respect to passenger capacity, towing ability and capacity, and storage volume.

When the vehicle 102 is assembled, the vehicle 102 may include various hardware and software components, such as, but not limed to, the one or more vehicle controllers 116 (represented as discrete controllers 116-A through 116-G). The controllers 116 may be configured to monitor and manage various vehicle 102 functions under the power of the vehicle battery and/or drivetrain. The controllers 116 may include one or more processors (e.g., microprocessors) configured to execute firmware or software programs stored on one or more storage devices of the controller 116. While the controllers 116 are illustrated as separate components, the vehicle controllers 116 may share physical hardware, firmware, and/or software, such that the functionality from multiple controllers 116 may be integrated into a single controller 116, and that the functionality of various such controllers 116 may be distributed across a plurality of controllers 116.

The vehicle controllers 116 may, for example, include, but are not limited to, a powertrain controller 116-A configured to manage engine operating components, a body controller 116-B configured to manage various power control functions such as exterior lighting, interior lighting, keyless entry, remote start, and point of access status verification, a radio transceiver controller 116-C configured to communicate with key fobs, mobile devices, or other local vehicle 102 devices, an entertainment controller 116-D configured to support voice command and BLUETOOTH interfaces with the driver and driver carry-on devices, a climate control management controller 116-E configured to monitor and manage heating and cooling system components (e.g., compressor clutch, blower fan, temperature sensors, etc.), a global positioning system (GPS) controller 116-F configured to provide vehicle location information, and a human-machine interface (HMI) controller 116-G configured to receive user input via various buttons or other controls, as well as provide vehicle status information to a driver.

The vehicle bus 118 may include various methods of communication available between the vehicle controllers 116, as well as, between the TCU 104 and the vehicle controllers 116. The vehicle bus 118 may further include one or more of a vehicle controller area network (CAN), an Ethernet network, and a media oriented system transfer (MOST) network.

The TCU 104 may include one or more processors 122 (e.g., microprocessors) configured to execute firmware or software programs stored on one or more storage devices 124 of the TCU 104. The TCU 104 may further include network hardware configured to facilitate communication between the vehicle controllers 116 and to facilitate communication between the vehicle 102 and other devices of the system 100 via the network 108. The network 108 may include one or more interconnected communication networks such as the Internet, a cable television distribution network, a satellite link network, a local area network, a wide area network, and a telephone network, as some non-limiting examples. As another example, the TCU 104 may be configured to communicate via one or more of Bluetooth, Wi-Fi, and wired USB network connections and facilitate data transmission between the network 108 and a mobile device (not shown) located in or paired with the vehicle 102.

The storage 124 may be configured to store the vehicle data 120. Moreover, prior to and/or subsequent to being stored in the storage 124, the vehicle data 120 may also be converted to one or more formats compatible with the network 108, the local server 110, and so on. As one example, the vehicle data 120 may be converted from encoding compatible with the vehicle bus 118 to encoding compatible with the network 108 and/or the local server 110.

The vehicle data 120 may include one or more vehicle 102 operating parameters captured by the vehicle controllers 116 or corresponding sensors. The vehicle data 120 may include, for example, operating parameters associated with one or more vehicle 102 subsystems, such as, but not limited to, climate control, infotainment and connectivity, propulsion, braking, steering, and traction battery subsystems. As some examples, the operating parameters may include fuel efficiency, acceleration and deceleration patterns, engine and/or battery temperature, efficiency, state-of-charge, and state-of-health, and climate control settings. It is also contemplated that the owner, user, or operator of the vehicle 102 may be able to select (or filter) which operating parameters may be captured, while prohibiting the capture or transfer of other operating parameters.

The vehicle data 120 may further include captured states, measurements, or maxima/minima values of the operating parameters during a predefined period of time, e.g., a 24-hour period, upon completion of a predefined number of ignition cycles, upon reaching a particular navigation destination or a plurality of destinations, as well as, any combination of the above criteria. In some cases, the vehicle data 120 may include image or sensor data captured along a navigation route of the vehicle 102, including, but not limited to, roadway features, such as ramps, road shoulders, signage, pavement type and condition, guardrails, bridges, pedestrian crossings, and so on.

The vehicle data 120 may include a single data segment, while in other cases the vehicle data 120 may be organized into multiple segments, portions, elements, or chunks, some or all of which may need to be combined in order to reveal a complete captured operating parameter value or a plurality of captured operating parameters. As one example, the vehicle data 120 collected on a given vehicle 102 may include a maximum speed portion, an engine temperature portion, an instant fuel economy portion, and a portion including geographic coordinates of a roadway pothole.

The data manager 114 of the TCU 104 may be configured to connect with the local server 110 and may transfer all or a portion of the vehicle data 120 to the local server 110. The local server 1110 may include a data store 126 configured to store the received vehicle data 120.

The data store 126 may be further configured to store additional information regarding the vehicle data 120. For example, the data store 126 may be configured to identify which vehicle controllers 116 are associated with which portion of the received vehicle data 120. The data store 124 may further store vehicle information 128 indicative of a unique identifier corresponding to the vehicle 102 that sent the vehicle data 120 and/or the specifications of the vehicle 102, such as a particular make and model of the vehicle 102, trim level, optional content, added accessories, and so on. As some nonlimiting examples, the vehicle information 128 may include information configured to identify the vehicle 102 or the configuration of the vehicle 102. For example, the vehicle information 128 may include a vehicle identification number (VIN) published to the vehicle bus 118, or subscriber identity module (SIM) information of the modem 106 such as international mobile station equipment identity (IMEI). Additionally or alternately, the vehicle information 128 may include version or configuration information for at least a portion of the hardware and software components of the vehicle controllers 116 of the vehicle 102.

The data store 126 may also be configured to store a plurality of vehicle data indices 130 corresponding to one or more portions or segments of the stored vehicle data 120. For example, the local server 110 may be configured to define the vehicle data indices 130 in response to receiving the vehicle data 120 from the vehicle 102. The local server 110 may include one or more devices configured to receive, from the vehicle 102, the vehicle data 120 generated by the vehicle controllers 116 or corresponding vehicle 102 sensors. Additionally or alternatively, the vehicle 102 may be configured to periodically, occasionally, or upon request, send all or a portion of the vehicle data 120 to the local server 110 located, for example, at a vehicle 102 owner's home, place of business, and so on.

In one example, in response to detecting that the vehicle 102 is in a parked state, e.g., according to a state reported by a transmission position sensor, and so on, the TCU 104 may be configured to connect to the local server 110 and send vehicle data 120 captured by the vehicle controllers 116 for storage in the data store 126. As an example, the network connection between the TCU 104 and the local server 110 may be a short-range high bandwidth network connection, such as a network connection that is based on WiGig communication protocol defining data transfer speeds up to 1000 times faster than a cellular data connection.

The local server 110 may include a processor (not shown) configured to use the vehicle data 120 to perform calculations prior to distributing downstream all or a portion of the received vehicle data 120. The local server 110 may be configured, for instance, to index the received vehicle data 120 and send the indices 130 to at least one of the end user data servers 132, e.g., the vehicle manufacturer server, vehicle data end customer server, and so on. In some cases, each of the vehicle data indices 130 may correspond to a single portion or segment of the vehicle data 120, while in other cases each of the indices 130 may correspond to multiple portions, segments, elements, or chunks, some or all of which may need to be combined in order to reveal value or values of the operating parameter(s) captured on the vehicle 102. As one example, in response to receiving the vehicle data 120 that includes a maximum speed portion or segment, an engine temperature portion or segment, an instant fuel economy portion or segment, and a portion or segment designating geographic coordinates of a roadway pothole, the local server 110 may be configured to generate the vehicle data indices 130 corresponding to each of the portions or segments. Additionally or alternatively, the local server 110 may be configured to combine a plurality of the vehicle data 120 segments, e.g., combine the engine temperature and the maximum speed segments, prior to creating the vehicle data index 130 corresponding to the combination of the two values.

The indices 130 corresponding to all or a portion of the vehicle data 120 stored on the local server 110 may, accordingly, comprise a unique identifier including a description of the vehicle data that the identifier references, such as, but not limited to, a time stamp value of a date and time when the vehicle controllers 116 captured the vehicle data 120 and/or a location indicator of a geographic location of the vehicle 102 when the vehicle controllers 116 captured the vehicle data 120. Additionally or alternatively, the indices 130, or other descriptors, indicators, or identifiers of the vehicle data 120, may include information describing the operating parameter or a combination of operating parameters they correspond to, such that the indices 130 may be used to decide whether the corresponding vehicle data 120 should be requested.

The local server 110 may include one or more devices configured to transmit to the end user data servers 132 the vehicle data indices 130 corresponding to the vehicle data 120 stored on the data store 126. The local server 110, accordingly, sends the indices 130, or other record descriptors, that are much smaller than the vehicle data 120 stored in the data store 126. By sending the indices 130 indicative of the vehicle data 120, and not the vehicle data 120 itself, the local server 110 may minimize an amount of network traffic. The distributed data storage system 100 may thereby assist in ensuring rapid data storage, availability of the data for analytics, and a reduction of costs associated with processing hardware and costs of network data transmission.

The local server 110 may include one or more devices configured to receive from the end user data servers 132 one or more requests to provide the vehicle data 120 corresponding to the vehicle data indices 130. The local server 110 may, for instance, receive a request to provide the vehicle data 120 from one or more end user data servers 132, e.g., a vehicle manufacturer server, vehicle data end customer server, and so on. The request sent by the end user data server 132 may include the previously distributed indices 130 corresponding to the stored vehicle data 120. Responsive to the request, the local server 110 may be configured to send all or a portion of the stored vehicle data 120 to the end user data server 132 from which the present request originated. The local server 110 may, accordingly, query the data store 126 to identify the portion or portions of the vehicle data 120 that correspond to the indices 130 included with the request. The local server 110 may then send the identified corresponding vehicle data 120 to the end user data server 132 that sent the request.

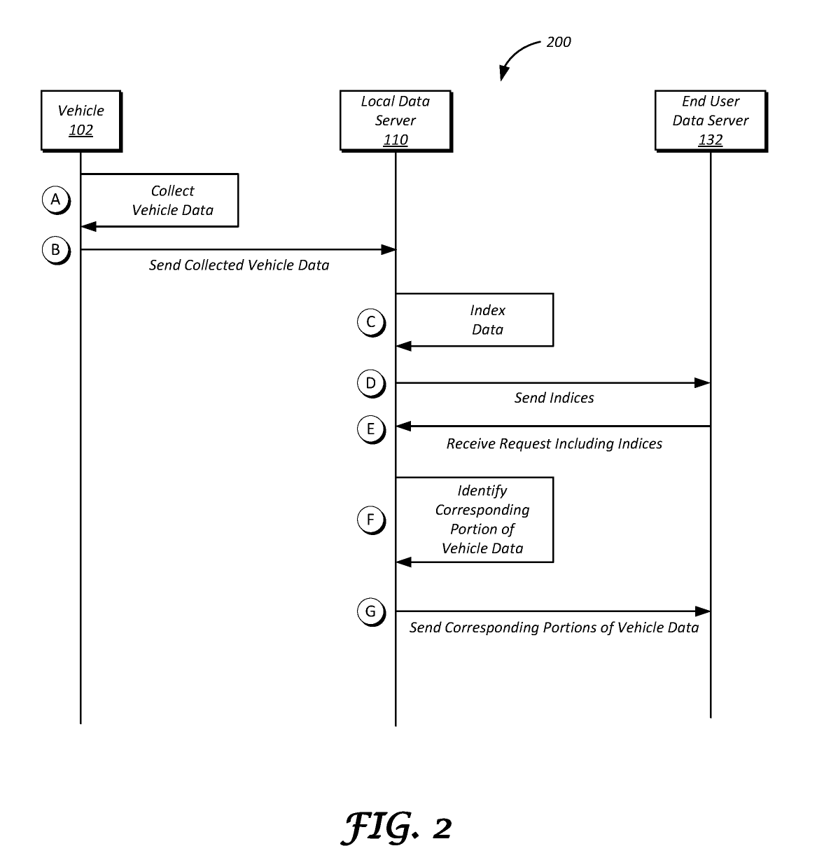

FIG. 2 illustrates an example distributed storage and access system data flow 200. The data flow 200 may begin at time index (A) when the vehicle 102 collects the vehicle data 120. The vehicle data 120 may be collected during a predefined time of day, for a predefined period of time, and/or in response to predefined criteria being met, such as, but not limited to, ignition state, vehicle speed, brake pedal position, and so on. The vehicle data 120 may include image or sensor data captured along a navigation route of the vehicle 102, including, but not limited to, one or more roadway features, captured states, measurements, or maxima/minima values of one or more operating parameters associated with the subsystems of the vehicle 102. In some examples, the vehicle data 120 may be captured according to a prior selection (or a filter) applied by the owner, user, or operator of the vehicle 102. Furthermore, each of the captured operating parameters, whether defining a state, a measurement, a maxima/minima value, and so on, may constitute a separate portion of the captured vehicle data 120. Thus, vehicle speed of the vehicle 102 may define a separate segment of the vehicle data 120 from that of a segment defining engine temperature of the same vehicle.

At time index (B), the vehicle 102 sends the collected vehicle data 120 to the local server 110. The vehicle 102 may be configured to connect with the local server 110 using the network 108 in response to detecting, for example, that the vehicle 102 is in a parked state, e.g., according to a state reported by a transmission position sensor, and is located in proximity with the local server 110. Upon detecting that the network connection with the local server has been established, the vehicle 102 may send the collected vehicle data 120 to the local server 110. As one example, the network connection between the vehicle 102 and the local server 110 may be a short-range high bandwidth network connection, such as a network connection that is based on WiGig communication protocol defining data transfer speeds up to 1000 times faster than a cellular data connection.

The local server 110, at time index (C), indexes the received vehicle data 120. In some cases, each of the vehicle data indices 130 may correspond to a single portion or segment of the vehicle data 120, while in other cases each of the indices 130 may correspond to multiple portions, segments, elements, or chunks, some or all of which may need to be combined in order to reveal value or values of the operating parameter(s) captured on the vehicle 102. As one example, in response to receiving the vehicle data 120 that includes a maximum speed portion or segment, an engine temperature portion or segment, an instant or average fuel economy portion or segment, and a portion or segment designating geographic coordinates of a roadway pothole, the local server 110 may be configured to generate the vehicle data indices 130 corresponding to each of the portions or segments. Additionally or alternatively, the local server 110 may be configured to combine a plurality of the vehicle data 120 segments, e.g., combine the engine temperature and the maximum speed segments, prior to creating the vehicle data index 130 corresponding to the combination of the two values.

At time index (D), the local server 110 sends the indices 130 to at least one of the end user data servers 132, e.g., the vehicle manufacturer server, vehicle data end customer server, and so on. Each of the indices 130 may comprise a unique identifier including a description of the vehicle data that the identifier references, such as, but not limited to, a time stamp value of a date and time when the vehicle controllers 116 captured the vehicle data 120 and/or a location indicator of a geographic location of the vehicle 102 when the vehicle controllers 116 captured the vehicle data 120. Additionally or alternatively, the indices 130, or other descriptors, indicators, or identifiers of the vehicle data 120, may include information describing the operating parameter or a combination of operating parameters they correspond to, such that the indices 130 may be used to decide whether the corresponding vehicle data 120 should be requested.

At time index (E), the local server 110 receives a request, from the end user data server 132, to provide all or a portion of the vehicle data 120. The request from the end user data server 132 may include one or more vehicle data indices 130. The local server 110, at time index (F), identifies, such as by querying the data store 126, the segment or segments of the vehicle data 120 corresponding to the indices 130 included in the request. At time index (G), the local server 110 sends the identified portions or segments of the vehicle data 120 that correspond to the indices 130 included in the request.

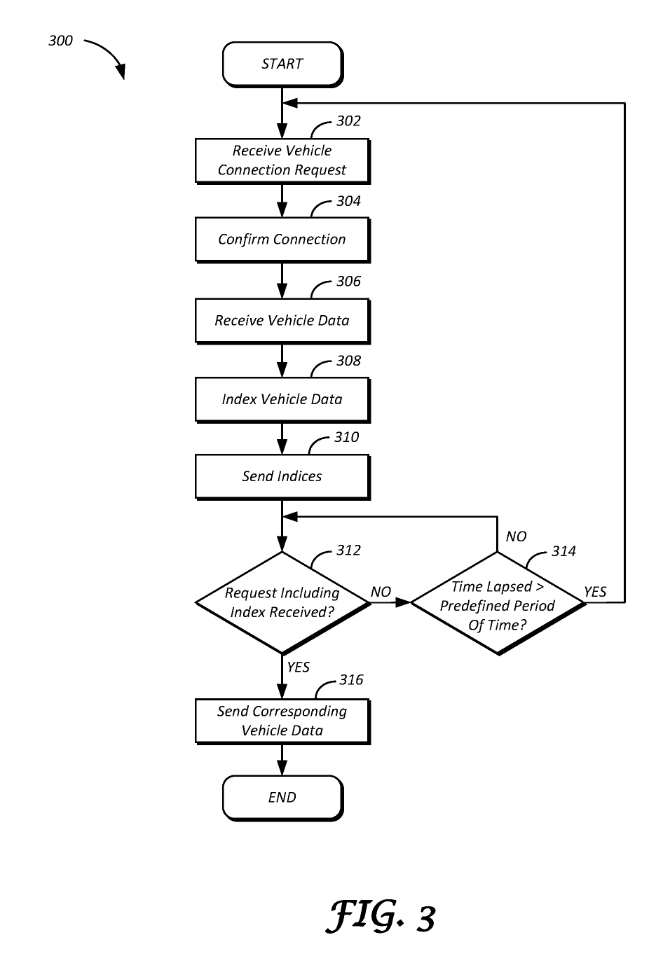

FIG. 3 illustrates an example process 300 for distributed storage and access of the vehicle data 120. The process 300 may begin at operation 302 where the local server 110 receives, from the vehicle 102, a request to establish a network connection. In some examples, the local server 110 may be configured to broadcast its own presence on the network 108, such that the vehicle 102 in proximity with the local server 110 may detect the broadcasts and send the request to establish a network connection.

The local server 110, at operation 304, sends a response to the vehicle 102 confirming that the connection has been established. In some examples, prior to sending the confirmation, the local server 110 may perform one or more authentication procedures to ensure that the request originated from an authorized vehicle 102.

The local server 110 receives the vehicle data 120 from the vehicle 102, at operation 306. The vehicle data 120 may include the operating parameters of the vehicle 102 captured by the vehicle controllers 116 or corresponding sensors, such as operating parameters associated, for example, with climate control, infotainment and connectivity, propulsion, braking, steering, and traction battery subsystems. As some examples, the operating parameters may include fuel efficiency, acceleration and deceleration patterns, engine and/or battery temperature, efficiency, state-of-charge, and state-of-health, and climate control settings. In some other cases, the vehicle data 120 may include image or sensor data captured along a navigation route of the vehicle 102, including, but not limited to, roadway features, such as ramps, road shoulder width, signage, pavement type and condition, guardrails, bridges, pedestrian crossings, and so on.

At operation 308, the local server 110 indexes the portions or segments of the received vehicle data 120. As one example, the received vehicle data 120 may include multiple segments, portions, elements, or chunks, e.g., a maximum speed data segment, an engine temperature data segment, an instant fuel economy data segment, and a segment including geographic coordinates of a roadway pothole. The local server 110 may generate the vehicle data indices 130 corresponding to each of the data segments and/or combine a plurality of the vehicle data 120 segments, e.g., combine the engine temperature and the maximum speed segments, prior to creating the vehicle data index 130 corresponding to the combination of the two values.

The local server 110, at operation 310, sends the vehicle data indices 130 corresponding to the vehicle data 120 stored on the data store 126 to the end user data servers 132. The local server 110, accordingly, sends the indices 130, or other record descriptors, that are much smaller than the vehicle data 120 stored in the data store 126, thus minimizing an amount of network traffic. The process 300 for distributed data storage may, thereby, assist in ensuring rapid data storage, availability of the data for analytics, and a reduction of costs associated with processing hardware and costs of network data transmission.

At operation 312, the local server 110 determines whether a request to provide one or more segments of the vehicle data 120 corresponding to the vehicle data indices 130 included with the request has been received from the end user data server 132. The local server 110 may, for instance, receive a request to provide the vehicle data 120 from one or more end user data servers 132, e.g., a vehicle manufacturer server, vehicle data end customer server, and so on, that includes the previously distributed indices 130 corresponding to one or more segments or portions of the stored vehicle data 120.

If the request has not been received, the local server 110 may determine, at operation 314, whether a time period lapsed since the vehicle data indices 130 have been sent to the end user data servers 132 exceeds a predefined period of time. The predefined period of time may be based on one or more of a period of time that the local server 110 makes the vehicle data 120 available to the end user data servers 132, a period of time before the vehicle data 120 currently stored on the data store 126 of the local server 110 will be overwritten by other vehicle data 120 received from the vehicle 102 and so on. If the predefined period of time has been exceeded, the local server 110 may decline to fulfill data requests including the vehicle data indices 130 sent out immediately prior and the process 300 may return to operation 302. Furthermore, if the predefined period of time has not been exceed, the process 300 may return to operation 312 where the local server 110 determines whether a request to provide one or more segments or portions of the vehicle data 120 has been received.

In response to determining that the request has been received, the local server 110, at operation 316, sends all or a portion of the stored vehicle data 120 to the end user data server 132 from which the current request originated. Upon querying the data store 126 to identify the portion or portions of the vehicle data 120 that correspond to the indices 130 included with the request, the local server 110 may then send the identified portions or segments of the vehicle data 120 to the end user data server 132 that sent the request. At this point, the process 300 may end. In some examples, the process 300 may be repeated in response to receiving a vehicle 102 request to establish a network connection or in response to another condition or request.

The processes, methods, or algorithms disclosed herein may be deliverable to or implemented by a processing device, controller, or computer, which may include any existing programmable electronic control unit or dedicated electronic control unit. Similarly, the processes, methods, or algorithms may be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms may also be implemented in a software executable object. Alternatively, the processes, methods, or algorithms may be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A system for a vehicle comprising:
a local data server configured to:
receive, via a network connection with the vehicle, data indicative of operating parameters of the vehicle;
define a plurality of indices, each index corresponding to a segment of the received data;
send the indices to an end user data server; and,
in response to a request, from the end user data server, including at least one of the indices, send the corresponding segment.

2. The system of claim 1, wherein each of the indices define at least one of a time stamp indicative of a date and time the data was collected or a location identifier indicative of a geographic location where the data was collected.

3. The system of claim 2, wherein the segment includes a subset of the data that was collected during the date and time defined by the corresponding index or that was collected in the geographic location defined by the corresponding index.

4. The system of claim 1, wherein the indices define a descriptor of at least one of the operating parameter that was captured, a value of the operating parameter that was captured, or a change in the value of the operating parameter that was captured.

5. The system of claim 4, wherein the segment includes a subset of the data that comprises the operating parameter, the value of the operating parameter, or the change in the value of the operating parameter described by the corresponding index.

6. The system of claim 1, wherein the operating parameters include at least one of a fuel efficiency value, acceleration and deceleration pattern, or climate control settings.

7. The system of claim 1, wherein the network connection between the local data server and the vehicle is a short-range high-speed network connection.

8. The system of claim 7, wherein the network connection is established in response to detecting at least one of a transmission of the vehicle being in a parked state or a vehicle speed being less than a predefined threshold.

9. A method comprising:
receiving, by a local data server connected with a vehicle using a communication network connection, data indicative of operating parameters of the vehicle;
defining a plurality of indices, each index corresponding to a segment of the received data;
sending the indices to an end user data server; and,
in response to a request, from the end user data server, including at least one of the indices, sending the corresponding segment.

10. The method of claim 9, wherein each of the indices define at least one of a time stamp indicative of a date and time the data was collected or a location identifier indicative of a geographic location where the data was collected.

11. The method of claim 10, wherein the segment includes a subset of the data that was collected during the date and time defined by the corresponding index or that was collected in the geographic location defined by the corresponding index.

12. The method of claim 9, wherein the indices define a descriptor of at least one of the operating parameter that was captured, a value of the operating parameter that was captured, or a change in the value of the operating parameter that was captured.

13. The method of claim 12, wherein the segment includes a subset of the data that comprises the operating parameter, the value of the operating parameter, or the change in the value of the operating parameter described by the corresponding index.

14. The method of claim 9, wherein the operating parameter includes at least one of fuel efficiency, vehicle speed, or climate control settings.

15. The method of claim 9, wherein the network connection between the local data server and the vehicle is a short-range high-speed network connection.

16. The method of claim 15, wherein the network connection is established in response to detecting at least one of a transmission of the vehicle being in a parked state or a vehicle speed being less than a predefined threshold.

17. A local data server comprising:
a processor connected to a transceiver and configured to establish, via the transceiver, a short-range high-speed network connection with a vehicle and a cellular network connection with a remote data server to send and receive data therefrom, wherein the processor is further configured to:
store the data received via the transceiver from the vehicle, the data being indicative of a plurality of operating parameters of the vehicle,
define a plurality of indices, each index corresponding to and describing a subset of the stored data,
send the indices to the remote data server, and,
in response to receiving, from the remote data server, a request including at least one of the indices, send the corresponding subsets.

18. The server of claim 17, wherein the local data server is further configured to combine at least two of the plurality of operating parameters prior to defining the index corresponding to and describing the combination.

19. The server of claim 17, wherein the subset includes at least one of a fuel efficiency operating parameter, a maximum vehicle speed operating parameter, and a climate control system operating parameter and the corresponding index includes at least one of a time stamp indicative of a date and time the subset was collected or a location identifier indicative of a geographic location where the subset was collected.

20. The server of claim 17, wherein the subset includes at least one of an image and a sensor output indicative of a roadway feature and the corresponding index includes at least one of a time stamp indicative of a date and time the subset was collected or a location identifier indicative of a geographic location where the subset was collected.
